(19) United States
(12) Patent Application Publication
(10) Pub. No.: US 2025/0192702 A1
(43) Pub. Date: Jun. 12, 2025

(54) IMAGE FORMING APPARATUS

(71) Applicant: CANON KABUSHIKI KAISHA, Tokyo (JP)

(72) Inventor: SHIGERU KAMEYAMA, Shizuoka (JP)

(21) Appl. No.: 18/929,713

(22) Filed: Oct. 29, 2024

(30) Foreign Application Priority Data
Dec. 7, 2023 (JP) 2023-206685

(51) Int. Cl. H02P 8/38; G03G 15/00

(52) U.S. Cl. CPC H02P 8/38; G03G 15/50

(57) ABSTRACT

An image forming apparatus includes a stepping motor including a coil and a rotor, a first detector for detecting a direction of the rotor, a setting unit for setting an advance angle and a second detector for detecting a rotational speed of the rotor. A controller rotates the stepping motor at a predetermined rotational speed and acquire a load torque based on an operation amount and the advance angle set by the setting unit. The setting unit updates the advance angle based on the load torque acquired by the controller, a target rotational speed of the stepping motor or a rotational speed value based on the rotational speed detected by the second detector. The controller controls a motor driver according to the direction of the rotor detected by first detector and the advance angle updated by the setting unit.

### FIELD OF THE INVENTION AND RELATED ART

The present invention relates to a control technology for a motor provided to an image forming apparatus.

As a driving source for the image forming apparatus, a stepping motor is used. As using the stepping motor, while it is possible to control a desired rotational speed and a rotational angle thereof with relative ease, there is a problem of a possibility of a step-out. Then, in order to prevent the step-out, a method, in which an encoder, etc. which detects operation of the stepping motor, is attached to perform feedback control, has been proposed. In Japanese Patent Application Laid-Open No. H10-174493, a control device, in which an encoder is provided to a stepping motor and which performs feedback control, is disclosed.

Methods which intends to reduce cost of a motor control circuit include the following. For example, there is a method in which a motor is driven without having a current control loop (without performing feedback control of a coil current value) but by control which only performs control on and off (bang-bang control) of voltage applied to a coil so as the coil current value not to exceed a target value. In this case, it is necessary to adjust timings to apply voltage with respect to detected electric angles of a rotor so that current is applied to the coil at appropriate timings corresponding to rotor operation of a stepping motor. Hereinafter, a timing of voltage application with respect to an electric angle is referred to as an advance angle (lead angle). In a case in which the advance angle is not set appropriately, problems such as decreased efficiency due to unnecessary current which does not contribute to generation of driving torque or insufficient driving torque due to insufficient current application may occur.

Generally, the advance angle is set so that the faster a rotational speed of the stepping motor, the more the advance angle is advanced, i.e., the earlier the timing of voltage application with respect to the electric angle of the rotor. However, in a case in which the advance angle is set according to the rotational speed of the motor, the advance angle may fluctuate due to fluctuation in the rotational speed thereof caused by unevenness in the rotation of the motor, etc., which may further worsen the unevenness in the rotation of the motor. In addition, it is desirable that the advance angle be set according to magnitude of load torque, however, the advance angle, which is less affected by assumed maximum load torque, is set. Thus, in a case in which the load torque is different from the assumed maximum load torque, the problems such as decreased efficiency due to unnecessary current which does not contribute to generation of driving torque or insufficient driving torque due to insufficient current application may occur.

### SUMMARY OF THE INVENTION

The present invention is conceived under such a background and is intended to suppress decrease in efficiency and insufficiency of driving torque upon performing control of a motor.

That is, there is provided an image forming apparatus for forming an image onto a recording material, the image forming apparatus comprising: a stepping motor including a coil and a rotor; a first detecting unit configured to detect a direction of the rotor; an exciting unit configured to excite the coil; a setting unit configured to set an advance angle which is a timing of exciting the coil to the direction of the rotor detected by the first detecting unit; a second detecting unit configured to detect a rotational speed of the rotor; and a control unit configured to control the stepping motor, wherein the control unit rotates the stepping motor at a predetermined rotational speed and acquires a load torque value based on an operation amount and the advance angle set by the setting unit, wherein the setting unit updates the advance angle based on the load torque value acquired by the control unit, a target rotational speed of the stepping motor or a rotational speed value based on the rotational speed detected by the second detecting unit, and wherein the control unit controls the exciting unit according to the direction of the rotor detected by first detecting unit and the advance angle updated by the setting unit.

According to the present invention, it becomes possible to suppress decrease in efficiency and insufficiency of driving torque upon performing control of a motor.

Further features of the present invention will become apparent from the following description of exemplary embodiments with reference to the attached drawings.

### BRIEF DESCRIPTION OF THE DRAWINGS

FIG. 1, part (a) and part (b), includes a configuration view of an image forming apparatus and a control configuration view of the image forming apparatus in Embodiments 1 through 3

FIG. 2 is a configuration view of a motor control portion in the Embodiments 1 through 3

FIG. 3, part (a) and part (b), includes a configuration view of a motor and a view describing an advance angle in the Embodiments 1 through 3

FIG. 4, part (a), part (b) and part (c), includes views describing relationship among a rotational speed, an operation amount and the advance angle in the Embodiments 1 through 3

FIG. 5, part (a) and part (b), includes a view illustrating advance angle curves and a view illustrating an example of setting of the advance angle in the Embodiments 1 through 3

FIG. 6 is a flowchart of a startup sequence in the Embodiment 1

FIG. 7 is a view illustrating an example of generation of a rotational speed value in the Embodiment 2

FIG. 8, part (i) and part (ii), includes views illustrating an example of setting of the advance angle in the Embodiment 3

### DESCRIPTION OF THE EMBODIMENTS

Hereinafter, an exemplary Embodiments of the present invention will be described with reference to the drawings. Incidentally, the Embodiments below are examples, and it is not intended to limit a scope of the present invention to contents of the Embodiments. In addition, in each figure below, components which are not necessary for description of the Embodiments are omitted therefrom.

### Embodiment 1

### <Image Forming Apparatus>

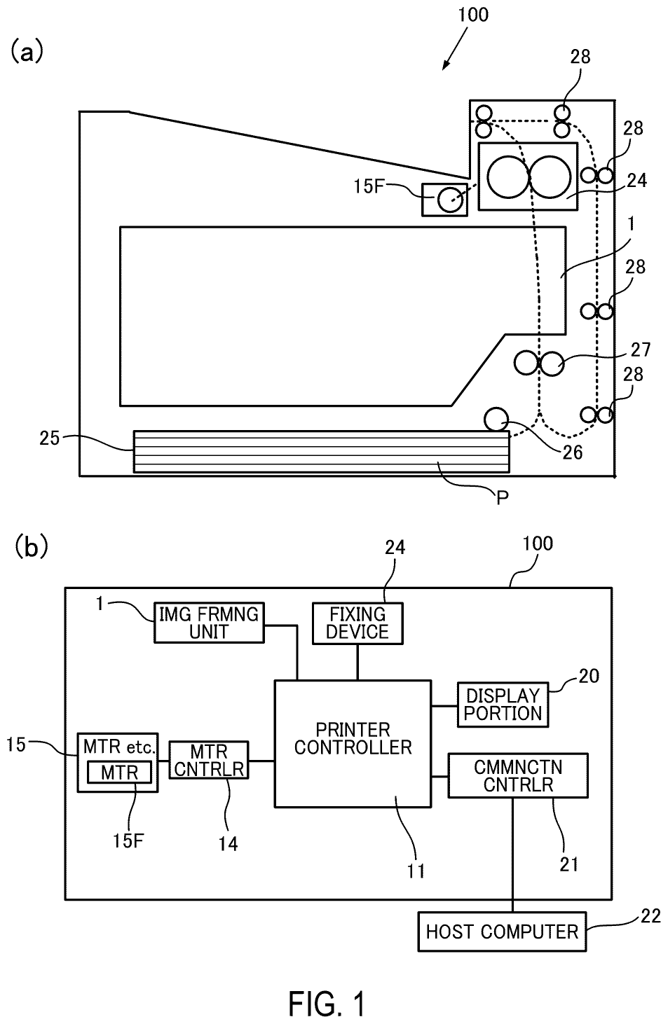

Part (a) of FIG. 1 is a configuration view of an image forming apparatus 100 of an Embodiment 1. The image forming apparatus 100 may be, for example, either of a printing device, a printer, a copy machine, a multifunction machine, or a facsimile machine.

A sheet P as a recording material accommodated in a sheet feeding cassette 25 of the image forming apparatus 100 is conveyed along a conveyance path by a sheet feeding roller 26 and a conveyance roller 27. An image forming unit 1 forms toner images of yellow, magenta, cyan and black and transfers these toner images to the sheet P which is conveyed along the conveyance path. A fixing device 24 includes a heating roller and a pressing roller, and heats and presses the sheet P, on which the unfixed toner images have been transferred, to fix the toner images on the sheet P. The sheet P on which the fixing process of the toner images is performed is discharged out of the image forming apparatus 100. A motor 15F is a driving source which rotates a pair of rollers of the fixing device 24, a sheet conveyance roller downstream of the fixing device 24 in a conveyance direction of the sheet P, and a group of conveyance rollers for double-side printing 28 which performs conveyance of the sheet P upon performing a double-side printing on the sheet P.

Part (b) of FIG. 1 illustrates a control configuration of the image forming apparatus 100. Upon receiving image data of an image to be formed from a host computer 22 via a communication controller 21, a printer control portion 11 forms the toner image on the sheet P by controlling the image forming unit 1 and fixes the toner image on the sheet P by controlling the fixing device 24. In addition, at this time, the printer control portion 11 controls a motor control portion 14 to control motors 15 including the motor 15F, and performs conveyance control of the sheet P, etc. In addition, the printer control portion 11 displays a state of the image forming apparatus 100 on a display portion 20. Incidentally, the printer control portion 11 includes a microcomputer and a memory.

The memory stores various control programs and data, and the microcomputer controls each portion of the image forming apparatus 100 based on the various control programs, the data, etc. stored in the memory.

### <Motor Control Portion>

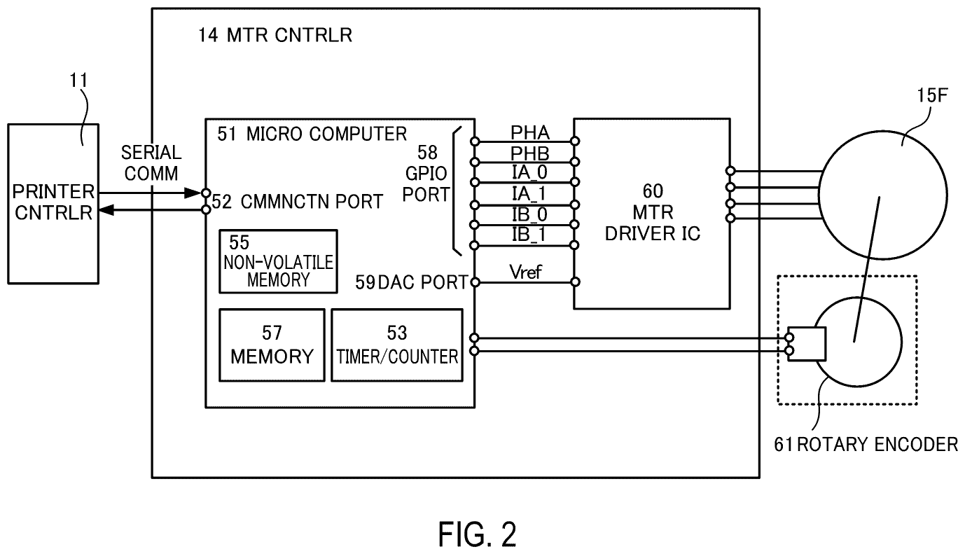

FIG. 2 illustrates an example of a configuration of the motor control portion 14. The motor control portion 14 as a control unit includes a microcomputer 51 and a motor driver IC 60 as an exciting unit. The microcomputer 51 is connected to the printer control portion 11 via a communication port 52 through a serial communication line and performs communication with each other. The microcomputer 51 outputs a control signal from a GPIO port 58 to the motor driver IC 60 and performs control of the motor driver IC 60. In addition, the microcomputer 51 outputs analog voltage from a DAC port 59 and uses the analog voltage as reference voltage for current control of the motor driver IC 60. In addition, the microcomputer 51 is provided with a timer/counter 53, which counts a number of pulses and performs measurement of a cycle of the pulse signal output by a rotary encoder 61, which will be described below. In the motor driver IC 60, two sets of H-bridge circuits for a phase A coil and for a phase B coil are built in, and the motor driver IC 60 performs driving of the motor 15F, which is a stepping motor, according to the control signal and the analog voltage output from the microcomputer 51. The control signal output from the GPIO port 58 will be described. A PHA signal controls the H-bridge circuit for the phase A coil, and a PHB signal controls the H-bridge circuit for the phase B coil. IA_0 and IA_1 signals switch a setting value of current for the phase A coil to 100%, 67%, 33% or 0% of a maximum current value. IB_0 and IB_1 signals also switch a setting value of current for the phase B coil in the same manner. By setting the above signals, the microcomputer 51 can perform the driving of the motor 15F, e.g., full step driving or half step driving, via the motor driver IC 60.

To voltage, which is input from the microcomputer 51 to a Vref terminal of the motor driver IC 60, the maximum current value of the coil is set. Output torque of the motor is approximately proportional to the maximum current value of the coil. The microcomputer 51 can change the output torque by changing the input voltage to the Vref terminal of the motor driver IC 60. Here, the larger the input voltage to the Vref terminal, the larger the output torque.

Incidentally, in the Embodiment 1, the analog voltage is input to the Vref terminal to change (set) the output torque, however, it is not limited thereto. For example, a pulse signal may be output from the microcomputer 51, converted to analog voltage by a low pass filter, and input to the Vref terminal. In this case, the output torque can be changed by changing duty (on duty) of the pulse signal. The greater the duty (on duty) of the pulse signal, the greater the output torque. The analog voltage or the duty of the pulse signal input to the Vref terminal to determine the output torque represents an operation amount.

In addition, the motor driver IC 60 is provided with a constant current control function as follows. The motor driver IC 60 determines the current value to be applied to the coil based on the voltage input to the Vref terminal and reference voltage for current, which is determined by ratio set by the IA_0 and IA_1 signals and the IB_0 and IB_1 signals. In other words, the motor driver IC 60 compares voltage Vr generated by an unshown current detecting resistor with the reference voltage for current. As a result of the comparison, if Vr≥the reference voltage for current, then the motor driver IC 60 once turns off a switching element which constitutes the H-bridge circuit built into the motor driver IC 60. After a predetermined period of time has elapsed, the motor driver IC 60 then turns on the switching element of the H-bridge circuit and applies the current to the coil, again. Thereafter, the motor driver IC 60 controls the current applied to the coil not to exceed a predetermined value by repeating this operation. In addition, the microcomputer 51 includes a nonvolatile memory 55 and a memory 57.

### <Configuration of the Motor>

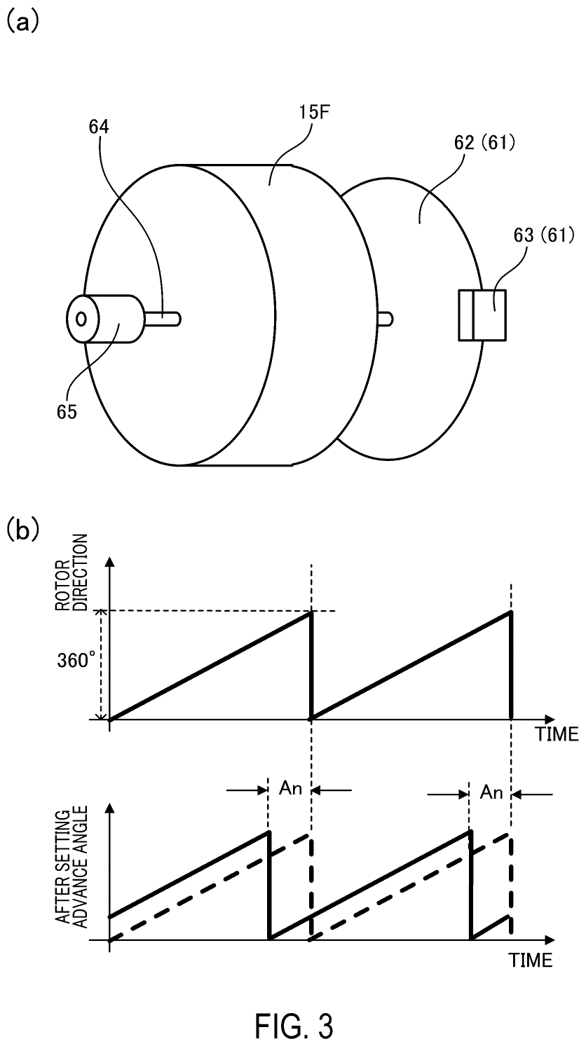

Part (a) of FIG. 3 is a configuration view of the motor 15F. The motor 15F includes a coil, a rotor, and a shaft 64 and is, for example, a stepping motor of two-phase bipolar which makes one full rotation (360 degrees rotation) in 48 steps mechanically. The stepping motor of two-phase bipolar has advantages such as high efficiency in use of windings by applying current in both directions and high output torque can be obtained since it is possible to perform control with high accuracy. Incidentally, in terms of the electric angle, one full rotation (360 degrees rotation) is made in four mechanical steps. In addition, the electric angle is what expresses 360 degrees for one cycle of a magnetic field of the rotor in angle. The motor 15F includes the two coils of the phase A and the phase B, and applies excitation current in two directions of positive or negative using the H-bridge circuits of the motor driver IC 60. Here, each state is referred to as following:

A state in which the phase A coil is excited in the positive direction is referred to as A;
a state in which the phase A coil is excited in the negative direction is referred to as /A;
a state in which the phase B coil is excited in the positive direction is referred to as B; and
a state in which the phase B coil is excited in the negative direction is referred to as/B.

The electric angle makes one full rotation (mechanical 4 steps) by the motor driver IC 60 switching the excitation phase as A and B→A and/B→/A and/B→/A and B (in a case of forward rotation with the full step). By repeating the above operation 12 times (switching the excitation phase 48 steps), the motor makes one full rotation mechanically.

Incidentally, in a case of exciting as
A and B→/A and B→/A and/B→A,/B.
then the motor 15F is rotated in reverse (reverse rotation). Hereafter, for example, when the rotor of the motor 15F is facing the electric angle in which A and B are excited, it may be referred to as “a position of the phases A and B”.

A gear 65 is attached to one end of the shaft 64 of the motor 15F, and the rotary encoder 61 is attached to the other end thereof. The rotary encoder 61 is constituted by a code wheel 62, which is provided with a slit, and a photo sensor 63, which detects the slit. The rotary encoder 61 outputs two pulses (a pulse A and a pulse B) with different phases. The rotary encoder 61 functions as a first detecting unit which detects the direction of the rotor of the motor 15F.

A count number of the pulses A and B output from the rotary encoder 61 per one mechanical full rotation is configured to be an integer multiple (48×n; n is a positive integer) of the number of steps required to make the motor 15F one full rotation mechanically (48 steps). In the Embodiment 1, since the motor 15F is mechanically rotated one full rotation in 48 steps in the full step driving, the count number of the pulses A and B are configured to be 480 pulses, respectively. Then, by counting leading edges and falling edges of pulses A and B output from the rotary encoder 61, the count number becomes 1920, which is a number of 40 times of 48 steps. Therefore, in the case of the full step driving, the excitation phase is switched every 40 counts of the count number of the pulses A and B output from the rotary encoder 61. On the other hand, in a case of the half step driving, the excitation phase is switched every 20 counts of the count number of the pulses A and B output from the rotary encoder 61.

Incidentally, a motor driver IC, which is capable of microstep driving, may be used as the motor driver IC 60, for example, to switch the excitation phase every 5 counts and perform ⅛ step driving.

As described above, by making the count number per one mechanical full rotation the integer multiple of the number of times of switching of the excitation phase required for one mechanical full rotation of the motor 15F, the switching timing of the excitation phase matches the counting timing. By this, management of the switching timing of the excitation phase becomes easier. In addition, it becomes possible to suppress worsening of unevenness in rotation which occurs due to a slight misalignment between the switching timing and the counting timing, such as switching the excitation phase every 2.5 counts. In addition, the forward/reverse rotation of the motor 15F can be determined from the phases of the pulses A and B of the rotary encoder 61.

### <Motor Driving Control>

Motor driving control by the motor control portion 14 will be described. The motor driving control includes excitation phase switching control and speed control, and each control includes an excitation phase switching loop and a speed control loop, respectively.

### (Excitation Phase Switching Control)

First, the excitation phase switching control will be described. The excitation phase switching control basically counts a number of pulses of the pulses A and B of the rotary encoder 61 and performs an operation to switch the excitation phase according to a value obtaining by offsetting the count value by an offset value. This offset value is the so-called advance angle, and in the Embodiment 1, the motor control portion 14 adjusts the advance angle, which is the offset value, according to driving conditions (rotational speed and load torque).

Part (b) of FIG. 3 is a view describing the advance angle, and an upper graph illustrates a temporal change of the direction of the rotor of the motor 15F (rotor direction, from 0° to 360°) detected by the rotary encoder 61. If the motor control portion 14 performs control to apply current based on the detection result of the rotary encoder 61, a delay in rise of the current may occur due to effect of inductance of the coil, etc. Therefore, as shown in a lower graph in part (b) of FIG. 3, an advance angle An is set so that a timing of voltage application is earlier than the direction of the rotor (relative to the electric angle of the rotor), which is detected by the rotary encoder 61 and indicated by a broken line. The motor control portion 14 determines timings of current application based on a virtual direction of the rotor, which is advanced by the advance angle An and indicated by a solid line. Hereafter, a value after offset of the count value counted by the rotary encoder 61 (value taking into account the advance angle) is referred to as an instructed value for the excitation phase, and an adjustment of the offset value is referred to as an advance angle adjustment. In the lower graph in part (b) of FIG. 3, the instructed value for the excitation phase corresponds to the solid line which is advanced by the advance angle An.

The motor control portion 14 (microcomputer 51) resets the count value of the number of pulses of the pulses A and B of the rotary encoder 61 to 0 in a state in which the electric angle of the rotor is fixed. In addition, the motor control portion 14 performs addition to or subtraction from the count value according to movement of the rotor (output conditions of the pulses A and B). Here, as described above, the count value of the pulse for one mechanical full rotation is configured to be 1920 counts (from 0 to 1919). Then the motor control portion 14 performs a count value processing, for example, in a case of adding 1 to 1919 (1919+1), which sets the value to 0, and in a case of subtracting 1 from 0 (0-1), which sets the value to 1919. By this processing, a range of the count value can be set from 0 to 1919. Incidentally, by performing the similar count value processing, a count may be performed in a range from 0 to 159 (160=1920/12) for one full rotation of the electric angle.

For example, in a case in which the motor 15F is rotated forward with the full step, the rotor is first drawn to the position of the phases A and B and the pulse count value is reset to 0. For drawing the rotor, for example, the/A and B phase excitation is performed for 500 ms, and then the A and B phase excitation is performed for 500 ms. By this, the direction of the rotor can be drawn to the electric angle of the phases A and B. In the Embodiment 1, the range of the count value is counted from 0 to 159, which corresponds to one full rotation of the electric angle.

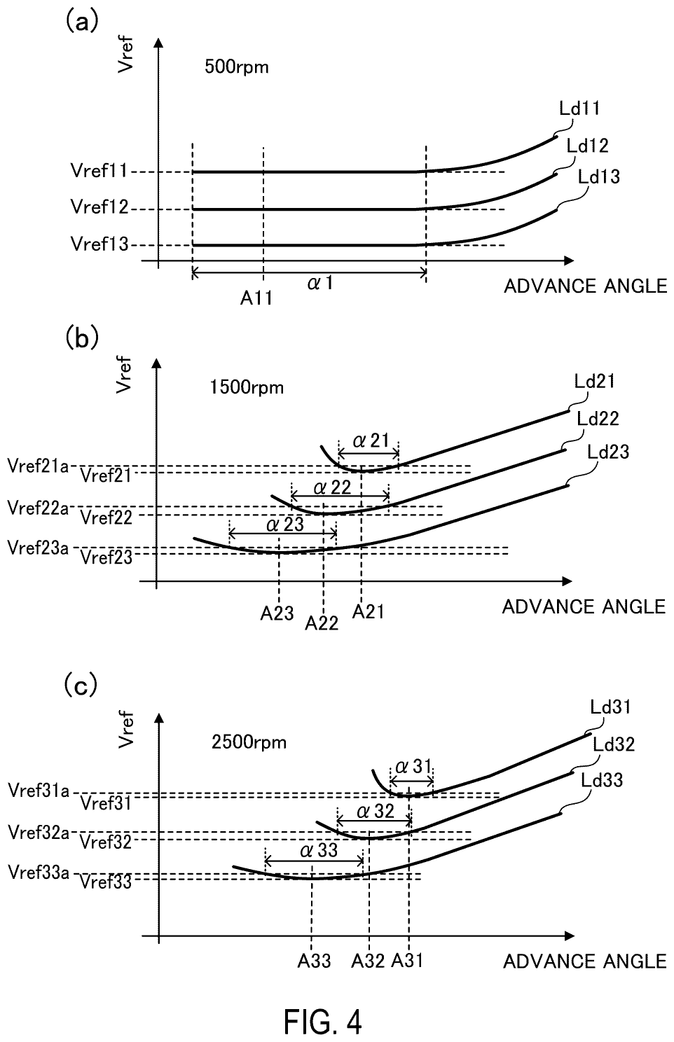

Next, as the offset value (advance angle), for example, a value in which 40 is added to the count value is defined as the instructed value for the excitation phase. Incidentally, a reason for determining the advance angle as 40 will be described in part (a) of FIG. 4 below. To the instructed value for the excitation phase as well, the similar processing of the count value as described above is performed. Therefore, the range of the instructed value for the excitation phase is also counted from 0 to 159. The motor control portion 14 switches the excitation phase, in the case in which the motor 15F is rotated forward with the full step, for example, by outputting the PHA and PHB signals according to the instructed value for the excitation phase, as following:
From 0 to 39, A and B;
from 40 to 79, A and/B;
from 80 to 119,/A and/B;
from 120 to 159,/A and B.

Therefore, when the rotor of the motor 15F is in the position of the phases A and B, the instructed value for the excitation phase is 40, then the phases A and/B are excited and torque which causes the rotor to rotate forward one step is generated.

Next, the speed control will be described.

### (Speed Control)

In the speed control, the motor control portion 14 (microcomputer 51) measures the cycle of the pulses A and B of the rotary encoder 61 to determine a current rotational speed and calculate a difference between the current rotational speed and a target rotational speed (hereinafter referred to as a rotational speed error). The motor control portion 14 functions as a second detecting unit which detects the current rotational speed of the motor 15F. The motor control portion 14 then performs, for example, PID operation to the calculated rotational speed error and outputs Vref voltage as an instruction for a current value to the motor driver IC 60.

### <On Vref Voltage, Load Torque, and the Advance Angle>

FIG. 4, part (a), part (b) and part (c), includes views illustrating relationship among the load torque, the advance angle and the voltage Vref for predetermined rotational speeds of the motor 15F and describing determination (setting) of the advance angle based on the rotational speed and the load torque of the motor 15F. Part (a) of FIG. 4 illustrates a case in which the rotational speed of the motor 15F is 500 rpm, part (b) of FIG. 4 illustrates a case in which the rotational speed of the motor 15F is 1500 rpm, and part (c) of FIG. 4 illustrates a case in which the rotational speed of the motor 15F is 2500 rpm. In all cases, horizontal axes represent the advance angle and vertical axes represent the voltage Vref. In addition, in part (a) of FIG. 4, Ld11 is a graph in a case of a predetermined load torque, Ld12 is a graph in a case of a smaller load torque than Ld11, and Ld13 is a graph in a case of a smaller load torque than Ld12 (Ld11>Ld12>Ld13). Similarly, in part (b) of FIG. 4, Ld21 is a graph in a case of a predetermined load torque, Ld22 is graph in a case of a smaller load torque than Ld21, and Ld23 is a graph in a case of a smaller load torque than Ld22 (Ld21>Ld22>Ld23). Furthermore, in part (c) of FIG. 4, Ld31 is a graph in a case of a predetermined load torque, Ld32 is a graph in a case of a smaller load torque than Ld31, and Ld33 is a graph in a case of a smaller load torque than Ld32 (Ld31>Ld32>Ld33).

As shown in FIG. 4, in a case in which the rotational speed of the motor 15F is a predetermined rotational speed, when the advance angle is changed in the same load torque, the Vref voltage required to obtain that load torque is changed. In the Embodiment 1, the advance angle which makes the Vref voltage lowest is selected (set). For example, as shown in part (a) of FIG. 4, in the case in which the rotational speed of the motor 15F is 500 rpm, the advance angle of which the Vref voltage corresponds to Vref11 is selected for the load torque Ld11. Similarly, for the load torque Ld12, the advance angle of which the Vref voltage corresponds to Vref12 is selected (set), and for the load torque Ld13, the advance angle of which the Vref voltage corresponds to Vref13 is selected (set). Incidentally, at 500 rpm, which is a lower rotational speed of the motor 15F, since the Vref voltage gets lower in a range of the acceptable advance angles (hereinafter referred to as an acceptable range of the advance angle) al, a degree of freedom in the selection of the advance angle is high. For example, the same advance angle A11 can be selected for any load torque. In the Embodiment 1, in the case in which the rotational speed of the motor 15F is 500 rpm, the advance angle A11 can be set to 40, regardless of the load torque, for example.

In the case in which the rotational speed of the motor 15F is 1500 rpm, which is shown in part (b) of FIG. 4, and in the case of the load torque Ld21, an advance angle A21 is selected since the Vref voltage becomes Vref21, which is the lowest, at the advance angle A21. Similarly, in the case of the load torque Ld22, an advance angle A22 is selected since the Vref voltage becomes Vref22, which is the lowest, at the advance angle A22, and in the case of the load torque Ld23, an advance angle A23 is selected since the Vref voltage becomes Vref23, which is the lowest, at the advance angle A23. Incidentally, in order to provide leeway for the selection of the advance angle, it may be configured as following.

For example, in the case of the load torque Ld21, if a range from Vref21 to Vref21a is acceptable as the Vref voltage, then the advance angle may also be selectable within an acceptable range of the advance angle α21. Similarly, in the case of the load torque Ld22, the advance angle may be selectable within an acceptable range of the advance angle α22, which corresponds to a range from Vref22 to Vref22a, and in the case of the load torque Ld23, the advance angle may be selectable within an acceptable range of the angle range α23, which corresponds to a range from Vref23 to Vref23a.

In the case in which the rotational speed of the motor 15F is 2500 rpm, which is shown in part (c) of FIG. 4, in the case of the load torque Ld31, an advance angle A31 is selected since the Vref voltage becomes Vref31, which is the lowest, at the advance angle A31. Similarly, in the case of the load torque Ld32, an advance angle A32 is selected since the Vref voltage becomes Vref32, which is the lowest, at the advance angle A32, and in the case of the load torque Ld33, an advance angle A33 is selected since the Vref voltage becomes Vref33, which is the lowest, at the advance angle A33. Incidentally, in order to provide leeway for the selection of the advance angle, it may be configured as following.

For example, in the case of the load torque Ld31, if a range from Vref31 to Vref31a is acceptable as the Vref voltage, the advance angle may also be selectable within an acceptable range of the advance angle α31. Similarly, in the case of the load torque Ld32, the advance angle may be selectable within an acceptable range of the advance angle α32, which corresponds to a range from Vref32 to Vref32a, and in the case of the load torque Ld33, the advance angle may be selectable within an acceptable range of the angle range a33, which corresponds to a range from Vref33 to Vref33a.

As described above, the advance angle is corresponded to the rotational speed and the load torque of the motor 15F. Specifically, when the rotational speed of motor 15F is 500 rpm, the advance angle A11 (e.g., 40) is set regardless of the load torque. In addition, when the rotational speed of the motor 15F is 1500 rpm and the load torque is Ld21, the advance angle A21 is set, for 1500 rpm and the load torque Ld22, the advance angle A22 is set, and for 1500 rpm and the load torque Ld23, the advance angle A23 is set, respectively.

Furthermore, when the rotational speed of the motor 15F is 2500 rpm and the load torque Ld31, the advance angle A31 is set, for 2500 rpm and the load torque Ld32, the advance angle A32 is set, and for 2500 rpm and the load torque Ld33, the advance angle A33 is set, respectively. Information associating the rotational speed, the load torque and the advance angle is preserved in the nonvolatile memory 55 in advance.

Incidentally, in a case in which the operation amount is duty of a PWM signal, the vertical axis in FIG. 4 may be read as the duty of the PWM signal.

### <Advance Angle Adjustment>

In the Embodiment 1, a rotational speed value of the motor SPD and a load torque value TRQ are used for the advance angle adjustment.

Here, the motor control portion 14 functions as a setting means which sets the advance angle, which is the timing for exciting the coil with respect to the direction of the rotor detected by the rotary encoder 61. The rotational speed value of the motor SPD is determined by an instructed value for the rotational speed of the motor (target speed) or the actual rotational speed of the motor 15F. In the Embodiment 1, as the rotational speed value of the motor SPD, the instructed value for the rotational speed of the motor is used. However, if a difference between the actual rotational speed of the motor and the instructed value for the rotational speed of the motor is beyond a predetermined value, then the actual rotational speed of the motor is used as the rotational speed value of the motor SPD.

The load torque value TRQ is generated by the load torque detected by a load torque detection, which will be described below.

Here, the advance angle fluctuates in interrelation with the fluctuation in the rotational speed of the motor 15F (see FIG. 4). In other words, the rotational speed and the advance angle of the motor 15F fluctuate in interrelation with each other. Therefore, as the rotational speed value of the motor SPD used for the advance angle adjustment, if the actual rotational speed of the motor 15F, which fluctuates, is always used, efficiency of the motor 15F may decrease due to the fluctuation in the rotational speed. Therefore, if the difference between the actual rotational speed of the motor and the instructed value for the rotational speed of the motor is a predetermined value or less, the instructed value for the rotational speed of the motor, which is a fixed value, is used as the rotational speed value of the motor SPD in order to avoid the decrease in the efficiency of the motor 15F due to the fluctuation in the rotational speed. On the other hand, for example, there is a case in which the load torque is large at a timing when the motor 15F is started and it takes time to reach the instructed value for the rotational speed of the motor.

In such cases, the difference between the actual rotational speed of the motor and the instructed value for the rotational speed of the motor is beyond the predetermined value. In this case, in order to make the rotational speed of the motor 15F quickly return to the instructed value for the rotational speed of the motor, the actual rotational speed of the motor is used as the rotational speed value of the motor SPD.

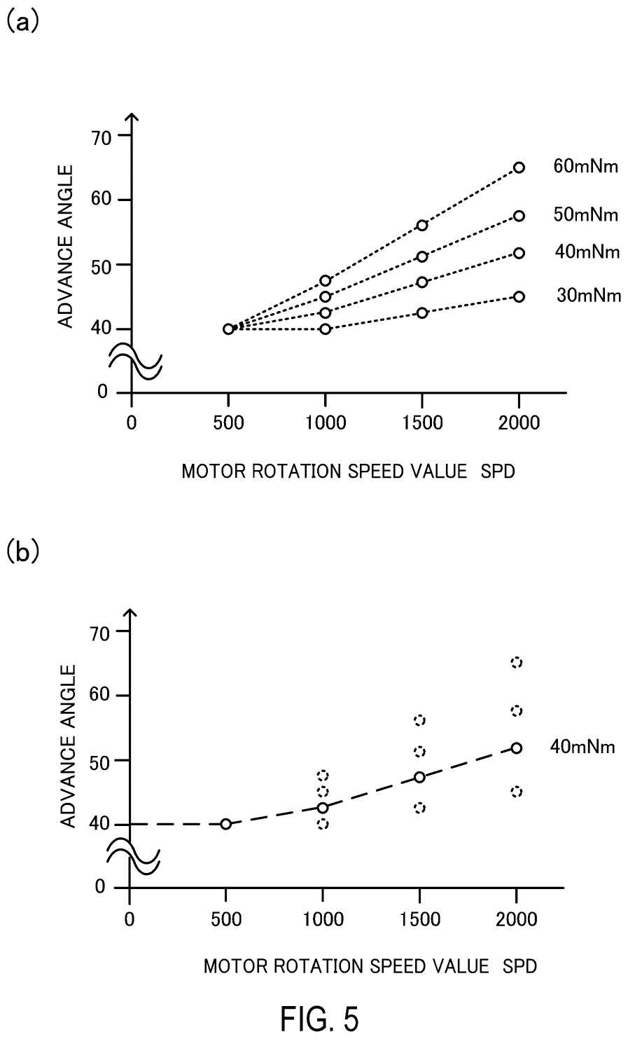

Part (a) of FIG. 5 is a graph illustrating the advance angle, which is set as described in FIG. 4, where a horizontal axis represents the rotational speed value of the motor SPD and a vertical axis represents an advance angle value. In part (a) of FIG. 5, examples of four different load torque values TRQ are shown. As described in FIG. 4, the optimum advance angle values for each driving condition are determined in advance and preserved in the nonvolatile memory 55. In the Embodiment 1, it is assumed that the advance angle values in cases in which the load torque values TRQ are 30 mN m, 40 mN m, 50 mN m and 60 mN m and the rotational speed values of the motor SPD are 500 rpm, 1000 rpm, 1500 rpm and 2000 rpm are preserved in the nonvolatile memory 55.

Incidentally, in a case in which a number of data is reduced to reduce a storage size of the nonvolatile memory 55, interpolated advance angle values may be calculated from the preserved data with respect to the actual load torque and the rotational speed of the motor. In addition, it may be configured to increase combinations of the load torque value TRQ and the rotational speed value of the motor SPD, and the advance angle value closer to the actual load torque and the rotational speed of the motor is used. Hereinafter, data set of the advance angle values with respect to the rotational speed value of the motor SPD for each load torque value TRQ is referred to as an advance angle curve.

An example of the advance angle adjustment is shown in part (b) of FIG. 5. First, the advance angle curve, which corresponds to the load torque value TRQ, is set. If there is no advance angle curve having the same value as the generated load torque value TRQ, the advance angle curve of the greater load torque value TRQ than the load torque value TRQ may be selected, or an interpolated advance angle curve may be generated from the advance angle curves of the preserved load torque values TRQ, which are below and above the load torque value TRQ. In part (b) of FIG. 5, it is assumed that the generated load torque value TRQ is 38 mN m, and the advance angle adjustment is performed using the advance angle curve of 40 mN m, which is greater than the load torque value TRQ.

The motor control portion 14 uses the advance angle value of 500 rpm when the rotational speed value of the motor SPD is between 0 and 500 rpm based on the advance angle curve of 40 mN m. In addition, when the rotational speed value of the motor SPD is between 500 rpm and 1000 rpm, the motor control portion 14 uses the advance angle value interpolated from the advance angle values of 500 rpm and 1000 rpm. The motor control portion 14 uses the same interpolated advance angle value in cases above 1000 rpm. Incidentally, the advance angle curve for each load torque value TRQ is used in the advance angle adjustment, however, it is not limited thereto but it may be configured that a calculation formula for calculating the advance angle value from the rotational speed value of the motor SPD and the load torque value TRQ is preserved in the nonvolatile memory 55, and the advance angle value is calculated by using the calculation formula in the advance angle adjustment.

### <Detection Method of the Load Torque>

Next, a detection method of the load torque for generating the load torque value TRQ will be described. In the Embodiment 1, the motor control portion 14 rotates the motor 15F at a constant speed in a low speed rotation number (second rotational speed) region in which the advance angle is less affected, for example, at 500 rpm, detects magnitude of the load torque based on magnitude of the Vref voltage (operation amount) at that time, and sets the magnitude of the load torque as the load torque value TRQ.

Here, a reason why the magnitude of the load torque is detected at 500 rpm, which is in the low speed rotation number region, is because the load torque is uniquely determined based on the Vref voltage, as shown in part (a) of FIG. 4. Specifically, when the rotational speed is 500 rpm, with respect to the advance angle A11, the load torque can be detected as Ld11 when the Vref voltage is Vref11, the load torque is Ld12 when the Vref voltage is Vref12, the load torque is Ld13 when the Vref voltage is Vref13, and so on. Incidentally, the rotational speed of the motor 15F upon detecting the load torque is not limited to 500 rpm, but may be any other rotational speed as long as the load torque can be detected based on the Vref voltage when the advance angle is a predetermined advance angle. The same is true in the case in which the operation amount is the duty of the PWM signal.

In a case in which the motor 15F is rotationally driven at a constant speed by the speed control, power input to the motor 15F varies corresponding to the load torque. In the Embodiment 1, since the power input to the motor 15F varies corresponding to the Vref voltage, as described above, the motor control portion 14 can detect the magnitude of the load torque based on the Vref voltage when the motor is rotated at the constant speed. Relationship among the Vref voltage, the advance angle and the load torque are determined in advance and preserved in the nonvolatile memory 55.

The load torque detection can be executed during initial operation after power of the image forming apparatus 100 is turned on, etc. Alternatively, the motor control portion 14 rotates the motor 15F once at 500 rpm, for example, upon starting of the motor 15F, and detects the magnitude of the load torque based on the magnitude of the Vref voltage at that time. The motor control portion 14 may then accelerate the rotational speed of the motor 15F to the desired target rotational speed (a first rotational speed>a second rotational speed).

In addition, the motor control portion 14 may also store the Vref voltage and the detected load torque value TRQ in the nonvolatile memory 55 (memory portion) in association with each other. By this, it becomes possible for the motor control portion 14 to acquire the load torque value TRQ based on the information stored in the nonvolatile memory 55 and the Vref voltage without performing the load torque detection thereafter.

(On a Difference from the Load Torque During the Print Operation)

In the load torque detection described above, the load torque may be different from that upon the actual print operation. In the Embodiment 1, the sheet P is not conveyed during the load torque detection, and the sheet P is conveyed during the print operation. Therefore, during the print operation, the load torque is increased by an amount for conveying the sheet P. Therefore, in the Embodiment 1, a trend of the increase of the torque due to the presence or absence of the conveyance of the sheet P is determined in advance, and a value in which the increased amount of the torque is added to the detected load torque is used as the load torque.

Incidentally, in the Embodiment 1, the actual load torque is calculated from the Vref voltage, and the obtained load torque is used as the load torque value TRQ, however, it is not limited thereto. For example, in a case in which relationship between the Vref voltage and the actual load torque is constant, such as a case in which the advance angle upon the load torque detection is fixed, the Vref voltage may be directly used as the load torque value TRQ.

### <Motor Driving Process>

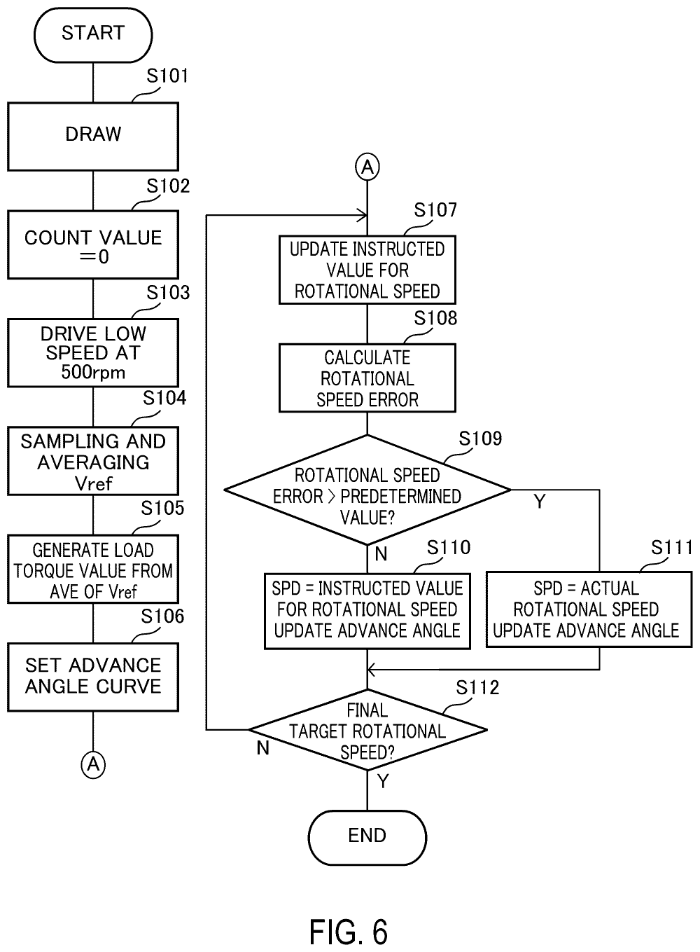

Next, a motor driving process which is executed by the motor control portion 14 will be described. In FIG. 6, a flowchart of a motor startup sequence, which is executed by the motor control portion 14, is illustrated. In step (hereinafter referred to as S) 101, the motor control portion 14 performs the drawing of the rotor of the motor 15F, and draws the rotor into the electric angle of the phases A and B. In S102, the motor control portion 14 resets the count value of the rotary encoder 61 to 0. In S103, the motor control portion 14 sets the instructed value for the rotational speed of the motor to 500 rpm and starts driving of the motor 15F at a low speed. Incidentally, the motor control portion 14 performs the aforementioned generation of the instructed value for the excitation phase, the excitation phase switching control and the speed control upon driving the motor. If the rotational speed of the motor reaches, for example, 500 rpm±3%, then the motor control portion 14 proceeds the process to S104.

In S104, the motor control portion 14 performs sampling of the Vref voltage currently output for a predetermined period of time until reaching a predetermined number of data. For example, the motor control portion 14 samples, every 1 ms, two hundreds (200) data. After the sampling is completed, the motor control portion 14 averages the sampled data. In S105, the motor control portion 14 generates the load torque value TRQ from the averaged data (Vref mean value) in S104 (load torque detection). Incidentally, the relationship among Vref voltage, the advance angle and the load torque are obtained in advance as described above and preserved in the nonvolatile memory 55.

In S106, the motor control portion 14 sets the advance angle curve according to the load torque value TRQ generated in S105, as described in part (b) of FIG. 5. Next, the motor control portion 14 starts accelerating the motor 15F up to a final target rotational speed. In S107, the motor control portion 14 updates the instructed value for the rotational speed of the motor. Here, the motor control portion 14 adds a predetermined value to the instructed value for the rotational speed of the motor so that the motor is accelerated at a predetermined acceleration.

In S108, the motor control portion 14 calculates the rotational speed error between the instructed value for the rotational speed of the motor updated in S107 and the actual rotational speed. In S109, the motor control portion 14 determines whether or not the rotational speed error calculated in S108 is greater than the predetermined value. In S109, if the motor control portion 14 determines that the rotational speed error is the predetermined value or less, then proceeds the process to S110. In S110, the motor control portion 14 updates the advance angle based on the advance angle curve set in S106 using the instructed value for the rotational speed of the motor updated in S107 as the rotational speed value of the motor SPD, and proceeds the process to S112.

In S109, if the motor control portion 14 determines that the rotational speed error is beyond a predetermined value, then proceeds the process to S111. In S111, the motor control portion 14 updates the advance angle based on the advance angle curve set in S106 using the actual rotational speed as the rotational speed value of the motor SPD, and proceeds the process to S112. For example, if the load torque value TRQ generated in S105 is 38 mN m, then the motor control portion 14 sets the advance angle curve as shown in part (b) of FIG. 5. And the motor control portion 14 then updates the advance angle value based on the advance angle value of 500 rpm and the advance angle value of 1000 rpm if the rotational speed value of the motor SPD in $110 or S111 is between 500 rpm and 1000 rpm, for example. In S112, the motor control portion 14 determines whether or not the instructed value for the rotational speed of the motor has reached the final target rotational speed, and if the motor control portion 14 determines that the final target rotational speed has not been reached, then proceeds the process back to S107, and if the motor control portion 14 determines that the final target rotational speed has been reached, then ends the startup sequence.

In this manner, the motor control portion 14 rotates the motor 15F at a predetermined rotational speed (500 rpm) and acquires the load torque value TRQ based on the operation amount and the set advance angle (e.g., 40). The motor control portion 14 updates the advance angle based on the acquired load torque value TRQ and the rotational speed value of the motor SPD based on the instructed value for the rotational speed of the motor (target rotational speed) or the current rotational speed of the motor 15F. The motor control portion 14 controls the motor driver IC 60 according to the direction of the rotor detected by the rotary encoder 61 and the updated advance angle. Here, the operation amount includes the Vref voltage, which is the analog voltage, or the duty of the PWM signal. When the instructed value for the rotational speed of the motor (target rotational speed) is the first rotational speed, the predetermined rotational speed is the second rotational speed which is slower than the first rotational speed or is less affected by the advance angle than the first rotational speed (e.g., 500 rpm). The motor control portion 14 updates the advance angle by using the instructed value for the rotational speed of the motor as the rotational speed value of the motor SPD in the case in which the difference between the instructed value for the rotational speed of the motor (target rotational speed) and the current rotational speed is within the predetermined range. On the other hand, the motor control portion 14 updates the advance angle by using the current rotational speed as the rotational speed value of the motor SPD in the case in which the difference is beyond the predetermined range. In addition, the nonvolatile memory 55 preserves the information associating the rotational speed value of the motor SPD, the load torque value TRQ, and the advance angle, or the calculation formula for calculating the advance angle from the rotational speed value SPD and the load torque value TRQ. The motor control portion 14 updates the advance angle based on the information or the calculation formula preserved in the nonvolatile memory 55. Incidentally, the motor control portion 14 may store the acquired load torque value TRQ in the nonvolatile memory 55 (memory portion). In this case, the motor control portion 14 may update the advance angle by reading out the load torque value TRQ stored in the nonvolatile memory 55. In addition, the rotary encoder 61 is set so that the count value of the number of pulses outputted per one full rotation of the motor 15F is the integer multiple of the number of times of switching the excitation phase of the coil required per one full rotation of the motor 15F.

As described above, according to the Embodiment 1, since the load torque is detected and the advance angle is set according to a number of rotation of the motor (motor rotational speed) and the load torque, it becomes possible to suppress the occurrence of the decreasing in efficiency of the motor and rotation defect due to insufficient output torque. In addition, since the advance angle is set based on the instructed value for the rotational speed of the motor, it does not occur that the advance angle fluctuates due to the unevenness in the rotation and further worsen the unevenness in the rotation. Since, in the case in which the difference between the instructed value for the rotational speed of the motor and the actual rotational speed becomes large (greater than the predetermined value), the advance angle is set based on the actual rotational speed, it becomes possible to suppress the occurrence of the decrease in efficiency of the motor and the rotation defect due to the insufficient output torque. As described above, according to the Embodiment 1, it becomes possible to suppress the decrease in efficiency and the insufficiency of the driving torque upon performing the control of the motor.

### Embodiment 2

Next, an Embodiment 2 will be described with focusing on differences from the Embodiment 1. In the Embodiment 2, a process for setting the rotational speed and the advance angle is different from the Embodiment 1. In the Embodiment 2, as the rotational speed value of the motor SPD used for the advance angle adjustment, a value obtained by applying a low pass filter processing to the actual rotational speed of the motor is used. For the low pass filter processing, various methods such as a moving average method and a method using first order lag system may be used. In addition, during acceleration or deceleration of the motor 15F, an acceleration or a deceleration and characteristics of the low pass filter processing are also reflected in the advance angle adjustment.

### <Low Pass Filter Processing>

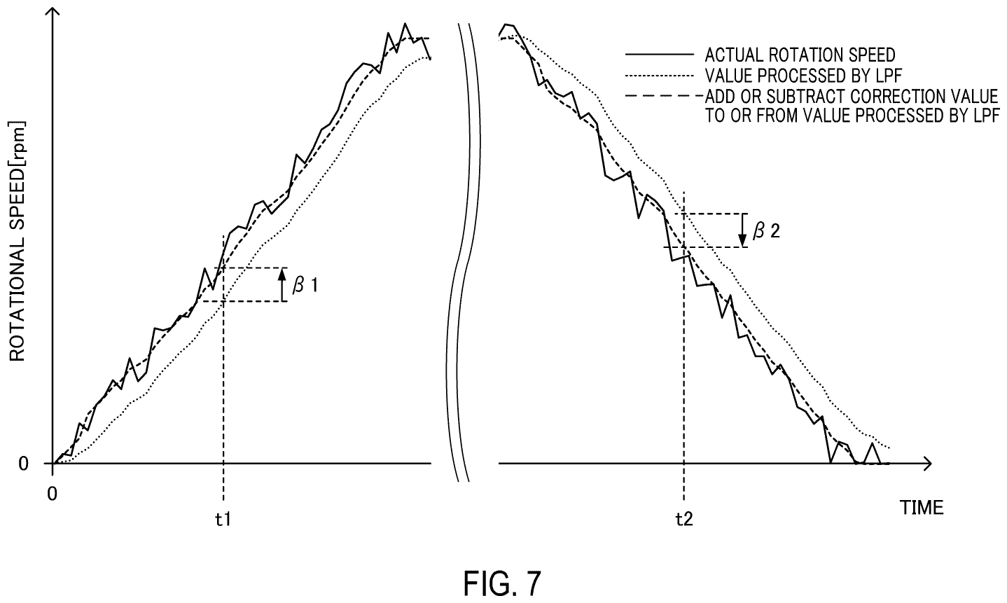

In FIG. 7, the rotational speed of the motor 15F during the acceleration/deceleration, values obtained by applying the low pass filter processing to the rotational speeds, and values obtained by adding or subtracting a correcting value to or from the value processed by the low pass filter are illustrated. In FIG. 7, a horizontal axis represents time and a vertical axis represents the rotational speed [rpm] of the motor 15F. In addition, a solid line represents the actual rotational speed of the motor 15F, a dotted line represents the rotational speed after the low pass filter processing (value processed by the low pass filter), and a broken line represents the rotational speed obtained by adding or subtracting the correcting value to or from the value processed by the low pass filter, respectively.

In the Embodiment 2, the motor control portion 14 performs the low pass filter processing to the rotational speed based on the detection result of the rotary encoder 61 in order to smooth out the fluctuation in speed of the rotational speed of the motor 15F. As shown in FIG. 7, during the acceleration/deceleration of the motor 15F, a difference arises between the actual rotational speed and the value processed by the low pass filter, depending on the acceleration or the deceleration and delay of the low pass filter processing. Incidentally, the delay of the low pass filter processing is due to a time constant of the low pass filter, and the greater effect of the low pass filter processing, the greater the delay, and the greater the difference between the actual rotational speed and the value processed by the low pass filter.

Therefore, the motor control portion 14 calculates the correcting value according to the characteristics of the low pass filter, the acceleration or the deceleration, the instructed value for the rotational speed of the motor, rotational speed information or the value processed by the low pass filter. As shown in FIG. 7, during the acceleration of the rotational speed of the motor 15F, a delay in the rotational speed after the low pass filter processing (dotted line) is generated compared to the actual rotational speed (solid line). Therefore, the motor control portion 14 corrects the delay caused by performing the low pass filter processing. In the Embodiment 2, the motor control portion 14 uses, as the rotational speed value of the motor SPD, the value obtained by adding a predetermined correcting value to the rotational speed processed by the low pass filter during the acceleration of the motor 15F. For example, as shown in FIG. 7, the control portion 14 adds a correcting value B1 to the rotational speed processed by the low pass filter at a timing t1. The motor control portion 14 sets the correcting values depending on the acceleration, the delay of the low pass filter processing, and the instructed value for the rotational speed of the motor. If the rotational speed value of the motor SPD obtained by adding the correcting value exceeds the instructed value for the rotational speed of the motor, the motor control portion 14 reduces the correcting value by that exceeding amount. In other words, the rotational speed value of the motor SPD becomes the same value as the instructed value for the rotational speed of the motor.

In addition, during the deceleration of the motor 15F, an advance of the rotational speed after the low pass filter processing (dotted line) is generated compared to the actual rotational speed (solid line). Therefore, the motor control portion 14 corrects the advance caused by performing the low pass filter processing. In the Embodiment 2, the motor control portion 14 uses, as the rotational speed value of the motor SPD, a value obtained by subtracting a predetermined correcting value from the rotational speed value processed by the low pass filter during the deceleration of the motor 15F. For example, as shown in FIG. 7, the motor control portion 14 subtracts a correcting value β2 from the rotational speed value processed by the low pass filter at a timing t2. The motor control portion 14 sets the correcting values depending on the deceleration, the advance of the low pass filter processing, and the instructed value for the rotational speed of the motor. If the rotational speed value of the motor SPD obtained by subtracting the correcting value, is less than the instructed value for the rotational speed of the motor, the motor control portion 14 increases the correcting value by the short amount. In other words, the rotational speed value of the motor SPD becomes the same value as the instructed value for the rotational speed of the motor.

Incidentally, in a period from when the acceleration of the motor 15F ends and the rotational speed thereof becomes the predetermined rotational speed to when the deceleration is started, the delay or the advance caused by the low pass filter processing during the acceleration and the deceleration as described above does not occur. Therefore, the value processed by the low pass filter is used as the rotational speed value of the motor SPD. Since other control in the Embodiment 2 is the same as in the Embodiment 1, description thereof will be omitted.

In this manner, when the motor 15F is rotated at a constant speed, the motor control portion 14 sets the advance angle by using the value processed by the low pass filter to the current rotational speed as the rotational speed value of the motor SPD. During the acceleration or the deceleration of the motor 15F, the motor control portion 14 sets the advance angle by using the value, obtained by correcting the value processed by the low pass filter according to the time constant, the acceleration or the deceleration, the instructed value for the rotational speed of the motor, the current rotational speed and the value processed by the low pass filter as the rotational speed value of the motor SPD. Specifically, during the acceleration of the motor 15F, the motor control portion 14 calculates the correcting value according to the time constant of the low pass filter, the acceleration, the instructed value for the rotational speed of the motor, the current rotational speed, the value processed by the low pass filter. The motor control portion 14 sets the advance angle by using the value corrected by adding the correcting value to the value processed by the low pass filter as the rotational speed value of the motor SPD. On the other hand, during the deceleration of the motor 15F, the motor control portion 14 calculates the correcting value according to the time constant of the low pass filter, the deceleration, the instructed value for the rotational speed of the motor, the current rotational speed, the value processed by the low pass filter. The motor control portion 14 sets the advance angle by using the value corrected by subtracting the correcting value from the value processed by the low pass filter as the rotational speed value of the motor SPD.

As described above, according to the Embodiment 2, since the advance angle is set after the actual rotational speed is processed by the low pass filter and the fluctuation in the rotational speed due to the unevenness in the rotation is reduced, it becomes possible to suppress that the advance angle is fluctuated by the fluctuation in speed due to the unevenness in the rotation and the unevenness in the rotation is further worsened.

As described above, according to the Embodiment 2, it becomes possible to suppress the decrease in efficiency and the insufficiency of the driving torque upon performing the control of the motor.

### Embodiment 3

Next, an Embodiment 3 will be described with focusing on differences from the Embodiments 1 and 2. In the Embodiment 3, a process for setting the advance angle in a case in which the load torque changes during the rotation of the motor 15F is different from the Embodiment 1. Since the motor 15F also drives the group of conveyance rollers for double-side printing 28 when the image forming apparatus 100 performs the double-side printing, the load torque changes between when the conveyance rollers for double-side printing are being driven and when not being driven. In addition, regardless of a single-side printing and the double-side printing, the load torque also changes at a timing when the sheet Pis fed by the sheet feeding roller 26 from the sheet feeding cassette 25 and a timing when a trailing end of the sheet P exits the sheet feeding roller 26. In the Embodiment 3, the advance angle is set in accordance with the changes in the load torque of the motor 15F caused by the image forming operation of the image forming apparatus 100.

### <Relation Between the Load Torque and the Advance Angle>

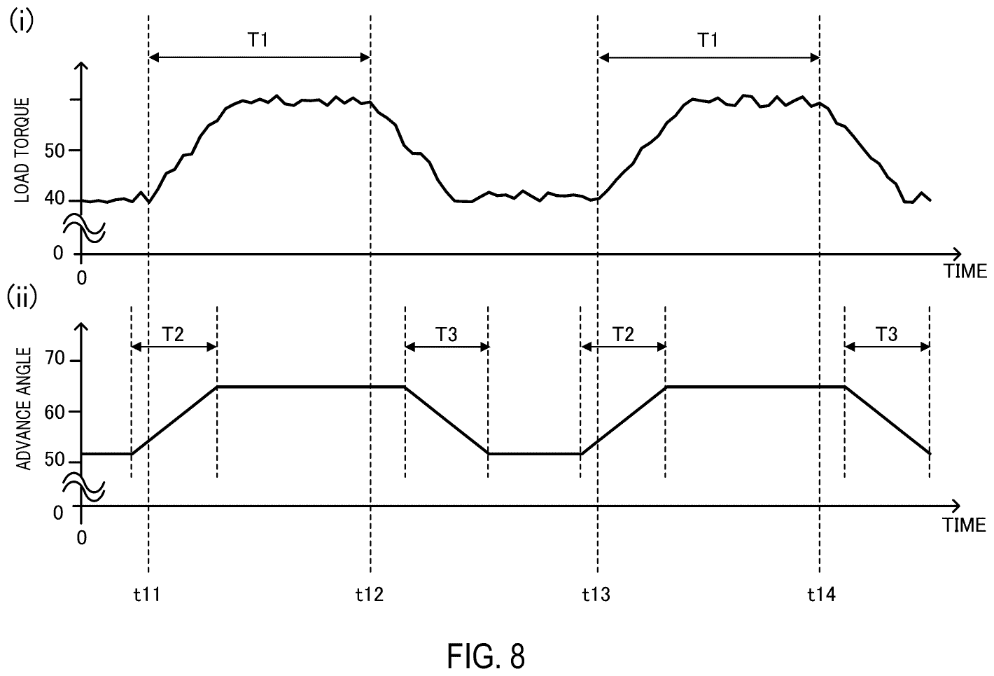

In FIG. 8, a state of the changes in the load torque and the change of the advance angle. Part (i) of FIG. 8 is a graph illustrating a temporal change of the load torque, and part (ii) thereof is a graph illustrating a temporal change of the advance angle. t11 through t14 represents timings, and T1 through T3 represents sections. A section T1 represents, for example, a section from a start to stop of the driving of the group of conveyance rollers for double-side printing 28. A section T2 represents, for example, a section in which the advance angle is gradually increased in response to the start of the driving of the group of conveyance rollers for double-side printing 28. A section T3 represents, for example, a section in which the advance angle is gradually reduced in response to the stop of the driving of the group of conveyance rollers for double-side printing 28.

The motor control portion 14 switches the advance angle curve to an advance angle curve which corresponds to the increased load torque in accordance with the timings t11 and t13, when the motor 15F also drives the group of conveyance rollers for double-side printing 28. And the motor control portion 14 returns the advance angle curve to the original advance angle curve in accordance with the timings t12 and t14, when the driving of the group of conveyance rollers for double-side printing 28 is stopped. At this time, the motor control portion 14 changes the advance angle gradually so that the advance angle is not changed abruptly (the section T2 and the section T3).

An increment of the load torque upon driving the group of conveyance rollers for double-side printing 28 can be determined by detecting the load torque in two states with and without the driving of the group of conveyance rollers for double-side printing 28 during an initial operation after the power of the image forming apparatus 100 is turned on, etc. The detection method of the load torque is the same as in the Embodiment 1. Since other control in the Embodiment 3 is the same as in the Embodiment 1, description thereof will be omitted. As described above, in the Embodiment 3, the advance angle can be set appropriately even in the case in which the load torque changes during the rotation of the motor 15F. In this manner, in the case in which the load torque changes during the driving of the motor 15F, the motor control portion 14 may transmit the load torque value TRQ in accordance with the changes in the load torque, select the advance angle curve which corresponds to that load torque value TRQ, and adjust the advance angle.

As described above, according to the Embodiment 3, it becomes possible to suppress the decrease in efficiency and the insufficiency of the driving torque upon performing the control of the motor.

### Other Embodiments

Incidentally, the motor control portion 14 can be implemented as a motor control device. In addition, the motor control portion 14 and a portion relating to the motor control of the printer control portion 11 can be implemented as a motor control device. Furthermore, in the present Embodiment, the control of the motor 15F which drives the fixing device 24 is exemplified and described, however, the present invention can be applied in the same way, for example, to a motor which drives each motor relating to the conveyance of the sheet in the image forming apparatus. Similarly, the present invention can be applied to a motor which drives a member in the image forming unit 1 of the image forming apparatus 100.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-206685 filed on Dec. 7, 2023, which is hereby incorporated by reference herein in its entirety.

What is claimed is:

1. An image forming apparatus for forming an image onto a recording material, the image forming apparatus comprising:
a stepping motor including a coil and a rotor;
a first detecting unit configured to detect a direction of the rotor;
an exciting unit configured to excite the coil;
a setting unit configured to set an advance angle which is a timing of exciting the coil to the direction of the rotor detected by the first detecting unit;
a second detecting unit configured to detect a rotational speed of the rotor; and
a control unit configured to control the stepping motor,
wherein the control unit rotates the stepping motor at a predetermined rotational speed and acquires a load torque value based on an operation amount and the advance angle set by the setting unit,
wherein the setting unit updates the advance angle based on the load torque value acquired by the control unit, a rotational speed value based on a target rotational speed of the stepping motor or the rotational speed detected by the second detecting unit, and
wherein the control unit controls the exciting unit according to the direction of the rotor detected by first detecting unit and the advance angle updated by the setting unit.

2. The image forming apparatus according to claim 1, wherein the operation amount includes an analog voltage outputted from the control unit to the exciting unit or a duty of a PWM signal.

3. The image forming apparatus according to claim 1, wherein when the target rotational speed is a first rotational speed, the predetermined rotational speed is a second rotational speed which is slower than the first rotational speed or is less affected by the advance angle than the first rotational speed.

4. The image forming apparatus according to claim 1, wherein the setting unit updates the advance angle by using the target rotational speed as the rotational speed value in a case in which a difference between the predetermined rotational speed and the rotational speed detected by the second detecting unit is within a predetermined range, and the setting unit updates the advance angle by using the rotational speed detected by the second detecting unit as the rotational speed value in a case in which the difference is beyond the predetermined range.

5. The image forming apparatus according to claim 1, wherein the setting unit updates the advance angle by using a value processed by a low pass filter to the rotational speed detected by the second detecting unit as the rotational speed value.

6. The image forming apparatus according to claim 5, wherein the setting unit updates the advance angle by using a value, obtained by correcting the value processed by the low pass filter according to a characteristics of the low pass filter and an acceleration or a deceleration, the target rotational speed, the rotational speed detected by the second detecting unit and the value processed by the low pass filter, as the rotational speed value during acceleration or deceleration of the stepping motor.

7. The image forming apparatus according to claim 6, wherein the setting unit calculates a correction value according to the characteristics of the low pass filter and the acceleration, the target rotational speed, the rotational speed detected by the second detecting unit and the value processed by the low pass filter, and updates the advance angle by using a value, corrected by adding the correction value to the value processed by the low pass filter, as the rotational speed value during the acceleration of the stepping motor.

8. The image forming apparatus according to claim 6, wherein the setting unit calculates a correction value according to the characteristics of the low pass filter and the deceleration, the target rotational speed, the rotational speed detected by the second detecting unit and the value processed by the low pass filter, and updates the advance angle by using a value, corrected by subtracting the correction value from the value processed by the low pass filter, as the rotational speed value during during the deceleration of the stepping motor.

9. The image forming apparatus according to claim 6, wherein the characteristics of the low pass filter includes a time constant of the low pass filter.

10. The image forming apparatus according to claim 1, further comprising a nonvolatile memory configured to preserve information associating the rotational speed value, the load torque value and the advance angle, or a calculation formula for calculating the advance angle from the rotational speed value and the load torque value,
wherein the setting unit updates the advance angle based on the information or the calculation formula preserved in the nonvolatile memory.

11. The image forming apparatus according to claim 1, wherein the control unit stores the load torque value which is acquired to a memory portion, and
wherein the setting unit updates the advance angle by reading out the load torque value stored in the memory portion.

12. The image forming apparatus according to claim 1, wherein in a case in which a load torque is changed during driving of the stepping motor, the control unit gives the load torque value in accordance with change of the load torque to the setting unit,
wherein the setting unit updates the advance angle according to the load torque value given by the control unit.

13. The image forming apparatus according to claim 1, wherein the first detecting unit is a rotary encoder configured to output a pulse signal according to rotation of the stepping motor, and
wherein the rotary encoder is set so that a count value of a number of pulses based on the pulse signal outputted per one full rotation of the stepping motor is an integer multiple of a number of times of switching an excitation phase of the coil required per one full rotation of the stepping motor.
